(19) United States
(12) Patent Application Publication
(10) Pub. No.: US 2010/0278237 A1
(43) Pub. Date: Nov. 4, 2010

(54) DATA PROCESSING CIRCUIT AND PROCESSING METHOD WITH MULTI-FORMAT IMAGE CODING AND DECODING FUNCTION

(75) Inventor: PO-YUAN YEH, Taipei (TW)

Correspondence Address: WPAT, PC;INTELLECTUAL PROPERTY ATTORNEYS, 7225 BEVERLY ST., ANNANDALE, VA, 22003, US

(73) Assignee: ASUSTeK COMPUTER INC., Taipei (TW)

(21) Appl. No.: 12/755,740

(22) Filed: Apr. 7, 2010

(30) Foreign Application Priority Data
Apr. 10, 2009 (TW) 098112046

(51) Int. Cl. H04N 7/26

(52) U.S. Cl. 375/240.14; 375/240.25; 375/E07.243; 375/E07.027

(57) ABSTRACT

The invention discloses a data processing circuit having a multi-format image coding and decoding function and a processing method thereof. The data processing circuit includes a retrieving unit, multiple executing units and an instruction decoding unit. The retrieving unit is used for retrieving multiple operation instructions and multiple original data from a memory. Each executing unit is used for executing an image format coding and decoding instruction to process multiple original data to multiple corresponding resulting data. The instruction decoding unit is used for analyzing the operation instructions, generating the corresponding image format coding and decoding instructions and outputting the image format coding and decoding instructions to the corresponding executing units according to the performance of the executing units.

### FIELD OF THE INVENTION

The invention relates to a data processing circuit and, more particularly, to a data processing circuit having a multi-format image coding and decoding function which may support multiple video formats and process the coding and decoding of data with the video formats at the same time.

### BACKGROUND OF THE INVENTION

With the progress of the science and technology, video coding and decoding technique becomes a key technique of information communication technology which mainly uses the multi-media technology, such as consumptive electronics, information and website communication. With regard to the international standard of the video coding and decoding technique, the video coding standard such as H.261, H,262, H.263 and H.264 of the international telecommunication union (ITU) Telecommunication Standardization Sector and the video coding standard such as the MPEG-1, MPEG-2, MPEG-4 and MPEG-21 adopted by the international standards organization (ISO) and the international electro-technical commission (IEC) are the main standards, and they may be adapted to a video conference and a video phone, a video storage (VCD/DVD/HD-DVD), a portable media player, a home media center, broadcast video (cable television, terrestrial broadcast, satellite television and digital subscriber line (DSL)), video monitoring and video streams.

There are two ways of constructing an image codec. The first is to use an application-specific integrated circuit (ASIC), and the second is to use a programmable single instruction multiple data (SIMD) processing unit. In the SIMD processing unit, a controller is used to control multiple processing units, and that is, each of the data in a group is processed in the same way, and all datum is processed at the same time to achieve the parallelism in space, such as the MMX or SSE of the Intel or the 3D Now! technique of the AMD.

The image codec constructed by the conventional ASIC has lower power consumption, but the hardware design, development and research consumes a lot of time. Each type of ASIC only may be used in an image codec supporting a single format, and the current video codec standard is variable. Thus, people would not like to run a risk to develop the ASIC circuit. In another aspect, if the SIMD processing unit is used to construct the image codec, the image codec may realize multiple types of software definition application and customized functions (using advanced language) easily, and it also may be used in various inherited hardware platform repeatedly. However, the image codec consumes a great deal of power and has a high demand for the software design and development.

Therefore, a new data processing circuit having a multi-format image coding and decoding function is needed. It should have the advantages of high variability, high performance, low complexity and low power consumption to solve the problem.

### SUMMARY OF THE INVENTION

Based on the requirements above, the invention discloses a data processing circuit having a multi-format image coding and decoding function. The data processing circuit may support multiple video formats, and it may encode and decode video data having multiple formats. The data processing circuit also has the advantages of high variability, high performance, low complexity and low power consumption, and that is, it has the advantages of both an application specific integrated circuit (ASIC) processing unit and a single instruction multiple data (SIMD) processing units in constructing an image codec.

The invention discloses a data processing circuit having a multi-format image coding and decoding function. The data processing circuit includes a retrieving unit, multiple executing units and an instruction decoding unit. The retrieving unit is used for retrieving multiple operation instructions and multiple original data from a memory. Each executing unit is used for executing an image format coding and decoding instruction to process the original data to multiple corresponding resulting data. The instruction decoding unit is used for analyzing multiple operation instructions, generating the corresponding image format coding and decoding instructions and outputting the image format coding and decoding instructions to the executing units according to the performance of the executing units.

The invention further discloses a data processing method having a multi-format image coding and decoding function. The method includes steps as follows. Multiple operation instructions and corresponding original data are retrieved from a memory. Multiple operation instructions are analyzed to make each operation instruction generate a corresponding image format coding and decoding instruction. The image format coding and decoding instructions are sent into the corresponding executing units, respectively, according to the performance of the executing units to process the original data to the corresponding resulting data.

### BRIEF DESCRIPTION OF THE DRAWINGS

These and other features, aspects and advantages of the present invention will become better understood with regard to the following description, appended claims, and accompanying drawings.

FIG. 1 is a schematic diagram showing the architecture of the data processing circuit having a multi-format image coding and decoding function;

FIG. 2A is a schematic diagram showing an improved architecture of the data processing circuit having the multi-format image coding and decoding function in the first embodiment of the invention;

FIG. 2B is a schematic diagram showing an improved architecture of the data processing circuit having a multi-format image coding and decoding function in the first embodiment of the invention;

FIG. 2C is schematic diagram showing an improved architecture of the data processing circuit with the multi-format image coding and decoding function in the first embodiment of the invention; and

FIG. 3 is a flow chart showing the data processing method having the multi-format image coding and decoding function in the first embodiment of the invention.

### DETAILED DESCRIPTION OF THE PREFERRED EMBODIMENT

The invention discloses a data processing circuit having a multi-format image coding and decoding function. The data processing circuit may support multiple video formats and may process coding and decoding of the video data having multiple formats at the same time. The data processing circuit has advantages hereinbelow.

First, the data processing circuit in the invention may process image signals having different coding formats at the same time. That is, the data processing circuit may process dividing images whose coding formats are at least two different coding formats of MPEG2, MPEG4, H.264, VC-1, RM and other future coding formats. This may improve the processing efficiency to the image data.

Second, when the hardware is updated or expanded, the software and firmware of the data processing circuit in the invention do not need to be modified, and that is, the data processing circuit may determine the best image data processing efficiency according to the hardware performance.

Third, since the data processing circuit may process multiple instructions at the same time in parallel, the number of times for the data to go into or out of the memory is reduced, and thus the time for processing image signals and the power consumption of the data processing circuit are reduced.

Fourth, since the data processing circuit of the invention is expandable, when the new coding format comes out in the future, only by comparing the old and new coding formats, the corresponding units of the data processing circuit which supports the old coding format is modified according to the characteristic of the new coding format. Therefore, the complexity in developing new processing circuit is reduced and the time for developing the new processing circuit is shortened.

These and other features, aspects and advantages of the present invention will become better understood with regard to the following description, appended claims, and accompanying drawings.

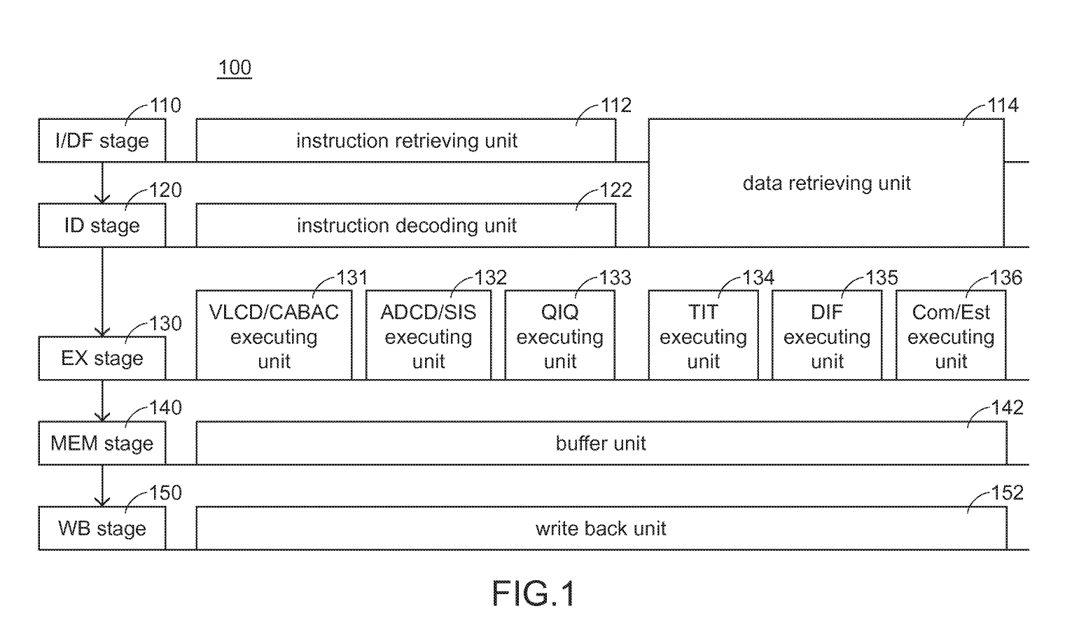

FIG. 1 is a schematic diagram showing the architecture of the data processing circuit having a multi-format image coding and decoding function. As shown in FIG. 1, the instruction cycle of the data processing circuit 100 having the multi-format image coding and decoding function has five stages, which are instruction fetch and execute (I/DF) stage 110, instruction decode (ID) stage 120, execution (EX) stage 130, memory access (MEM) stage 140 and write back (WB) stage 150.

In the I/DF stage 110, an instruction retrieving unit 112 and a data retrieving unit 114 are included. The direct memory access (DMA) is used to retrieve the data needed by the operation instruction and the operation unit from the memory (not shown). In the ID stage 120, the instruction decoding unit 122 for decoding the operation instruction and sending the operation instruction to the corresponding executing unit in EX stage 130 is included. In the EX stage 130, a variable length coding or context adaptive binary arithmetic coding (VLCD/CABAC) executing unit 131, an alternating current/direct current (AC/DC) prediction or scanning and inverse scanning (ADCD/SIS) executing unit 132, a quantization and inverse quantization (QIQ) executing unit 133, a transform and inverse transform (TIT) executing unit 134, a de-blocking filter (DIF) executing unit 135 and an intra/motion estimation and compensation (Com/Est) executing unit 136 are included. Each of the executing units at least comprises an operation unit for executing the image format coding and decoding instructions. The operation units are a variable length coding or context adaptive binary arithmetic coding (VLCD/CABAC) executing unit, an alternating current/direct current (AC/DC) prediction or scanning and inverse scanning (ADCD/SIS) executing unit, a quantization and inverse quantization (QIQ) executing unit, a transform and inverse transform (TIT) executing unit, an de-blocking filter (DIF) executing unit or an intra/motion estimation and compensation (Com/Est) executing unit. In the MEM stage 140, a buffer unit 142 is used to store registering data sent by any one of the executing units 131 to 136, and the registering data also may be returned to any one of the executing units 131 to 136. In the WB stage 150, a write back unit 152 is used to store the decoded image data or the coded bit-stream in the memory.

After the instruction decoding unit 122 is used to decode the data in the ID stage 120, the data processing circuit in the invention may determine the flow direction of the image data according to the characteristic of the instruction and the performance of the executing units in the EX stage 130. This is the main characteristic of the invention, and thus in the EX stage 130, the executing units 131 to 136 may execute multiple coding instructions and decoding instructions for data having various video standards such as the H.264, the MPEG4, the MPEG2, the VC-1, the RM. In addition, the executing units 131 to 136 in the EX stage 130 may sequentially executes instructions, where all the units operate at the same time to finish the single format image coding.

In the following part, the original image data inputted by the retrieving unit 114 needs to be coded into the H.264 and MPEG4 formats. When the original image data is compressed in the MPEG4 format, the image data retrieved from the retrieving unit 114 is made to pass through the Com/Est executing unit 136 to perform a dynamic estimation to obtain the motion vector and the sum of absolute differences (SAD) of the image data. When the SAD is too large, the original image data is sent to the TIT executing unit 134 to perform the discrete cosine transform (DCT). On the contrary, the difference value of the current image data and the previously restored image data are operated, and the difference value is sent to the TIT executing unit 134 to perform the DCT. Then, the data finishing the DCT is quantified in the QIQ executing unit 133, and the quantified data is sent to the ADCD/SIS executing unit 132 to perform the AC/DC prediction. Afterwards, the data finishing the AC/DC prediction is sent to the VLCD/CABAC executing unit 31 to perform the variable length coding. The original image data are compressed to be the basic layer bit stream and transmitted to the buffering unit 142. Then, the base layer bits stream is stored in the memory via the write back unit 152.

In addition, besides the ADCD/SIS executing unit 132 performing the AC/DC prediction, the quantified data also may be transmitted to the QIQ executing unit 133 at the same time to be inverse-quantified. Then the inverse-quantified data are transmitted to the TIT executing unit 134 to perform the DCT. Then, the Com/Est executing unit 136 performs a motion compensation according to the operated result of the dynamic estimation to rebuild an image to be the reference image for the next image.

In another aspect, if the original image data needs to be compressed in the H.264 format, the data processing circuit in the invention may determine the flow direction of the original data according to the current performance of each executing unit in the EX stage 130 and the differences between the MPEG4 image compression and the H.264 image compression. The differences between the MPEG4 image compression and the H.264 image compression includes the following.

The H.264 image compression has seven image prediction macro block sizes, and they are 6×16, 16×8, 8×16, 8×8, 8×4, 4×8, 4×4. In addition, according to the different settings of compression software, the reference images may be previous 1˜31 images and next 1˜31 images, and the motion vector may achieve the accuracy up to ¼ pixels. Thus, the predicting accuracy on the timer shaft can be increased a lot. In the transforming process, when the integral DCT transformation of the H.264 takes 4×4 matrix as the transformation basic unit, and namely, an integer is used as the transfer coefficient, the problem that the restored data cannot match due to the decimal operation does not occur when the TIT executing unit 134 performs the inverse transformation. To the quantified transformation coefficient, a CAB AC coding mode is used. That is, the CABAC coding mode in the VLCD/CABAC executing unit 131 may count the appearance probability of the special code according to the content of the coding. Then the coding schedule most suitable to the current image is generated, and the VLCD also can perform a context adaptive variable length code (CAVLC) coding of the H.264.

In addition, for the differences in the compression mode, H.264 has different profiles according to different contents. The profiles are Baseline Profile, Main Profile and Extension Profile. Each profile includes a corresponding video size and bit rate class. In the definition, the H.264 has level 1 to level 5.1, which cover the application ranges with different resolution and the flow rate such as small picture and HD picture.

In the invention, the data processing circuit may determine to perform the H.264 image compression or perform a certain compression flow path in the H.264 image compression according to the profile of the H.264 and whether each of the VLCD/CABAC executing unit 131, the ADCD/SIS executing unit 132, the QIQ executing unit 133, the TIT executing unit 134, the DIF executing unit 135 and the Com/Est executing unit 136 in the EX stage 130 is in an idle state.

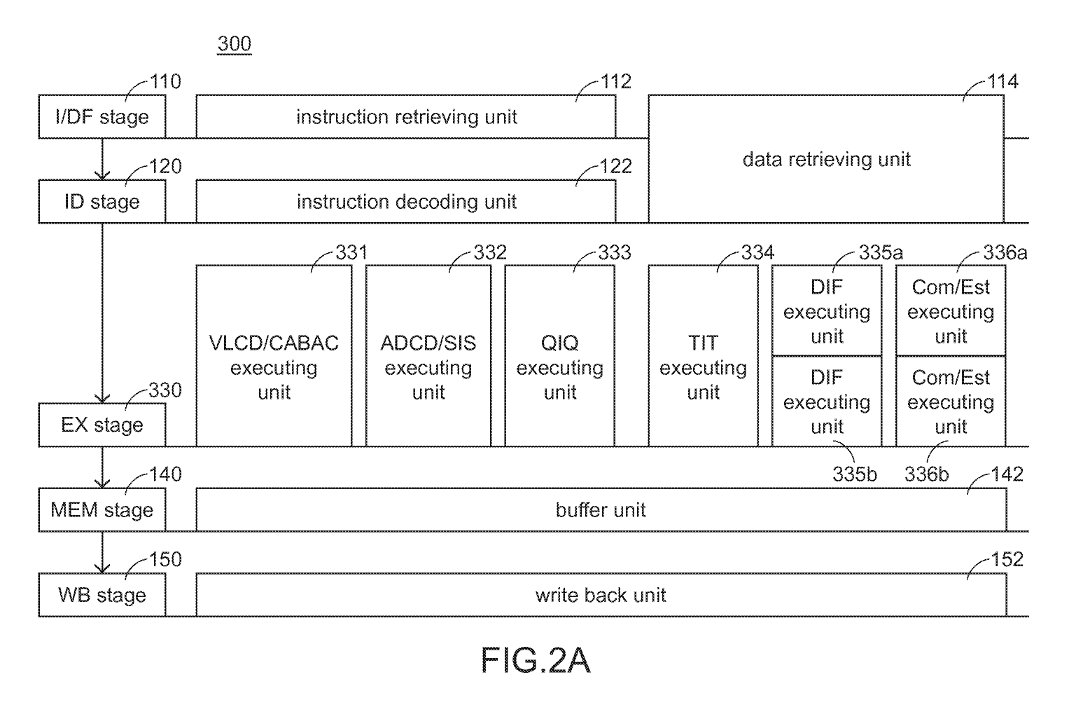

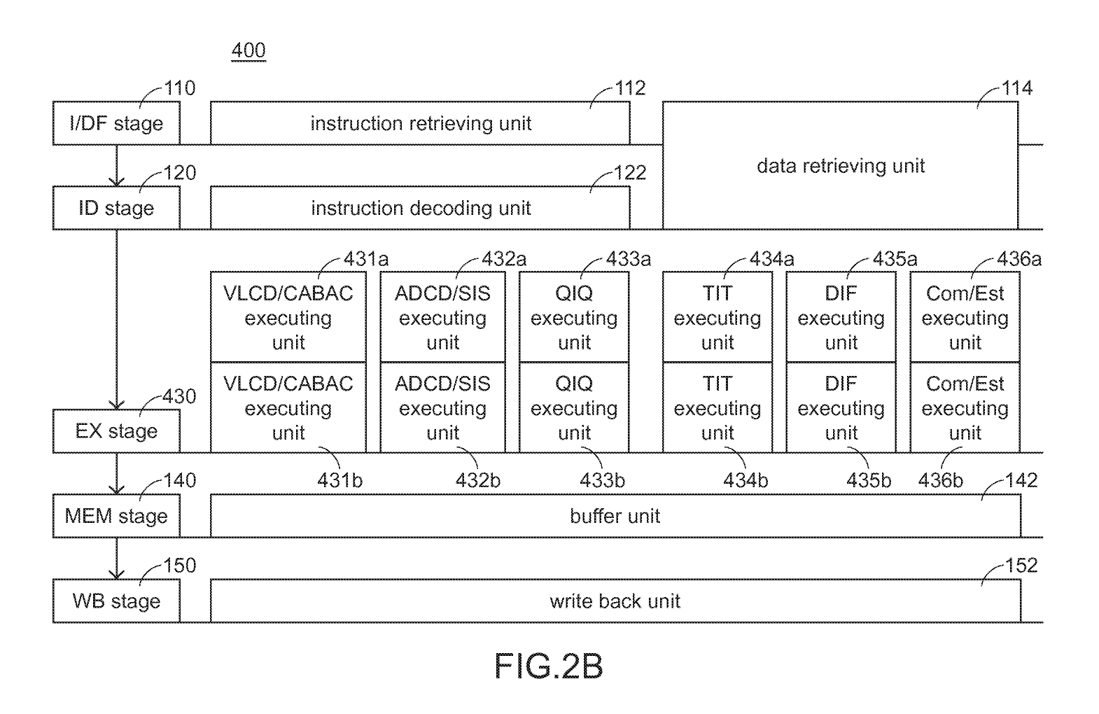

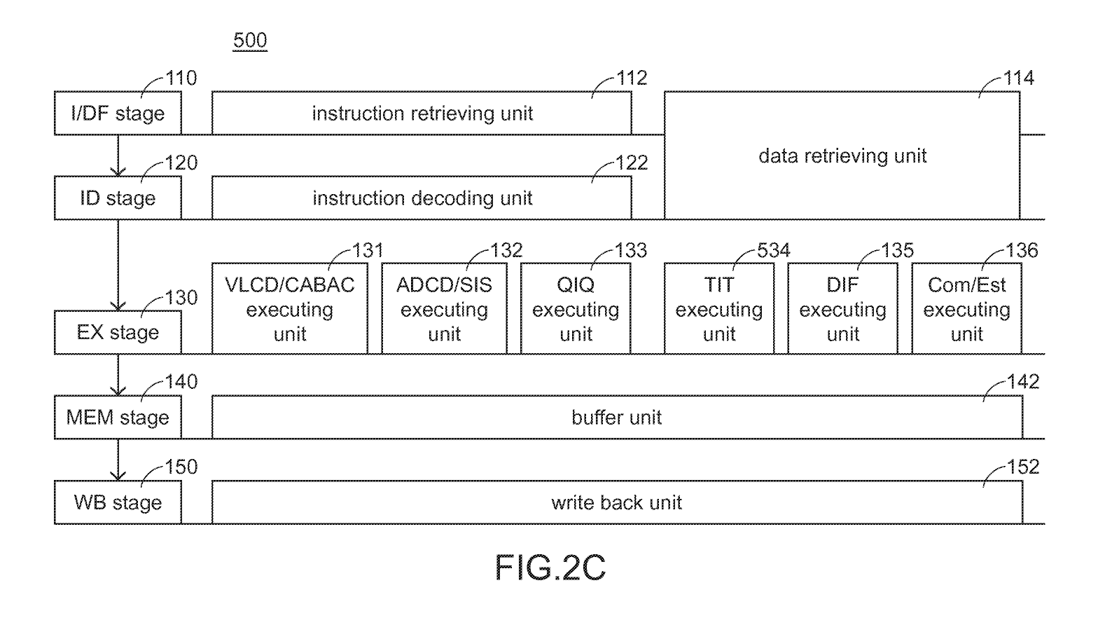

In addition, the data processing circuit in the invention is expandable. For example, If the speed of coding or decoding the image data needs to increase, the number of any of the VLCD/CABAC executing unit 131, the ADCD/SIS executing unit 132, the QIQ executing unit 133, the TIT executing unit 134, the DIF executing unit 135 or the Com/Est executing unit 136 in the EX stage 130 may be increased. After the hardware is updated or expanded, the software and firmware of the data processing circuit in the invention do not need to be modified. That is, the data processing circuit may determine the best processing efficiency of the image data according to the performance of the hardware, as shown in FIG. 2A.

FIG. 2A is a schematic diagram showing an improved architecture of the data processing circuit having the multi-format image coding and decoding function in the first embodiment of the invention. The EX stage 330 of the data processing circuit 300 includes two DIF executing units 335a and 335b and two Com/Est executing units 336a and 336b. The speed of coding or decoding the image data is increased due to the design. In addition, the parts in FIG. 2A and FIG. 1 having the same symbols have the same functions and characteristics, which are described in the illustration for FIG. 1.

In addition, when the new coding format comes out in the future, the data processing circuit in the invention only needs to compare the new coding format with the old coding format. The corresponding unit supporting the old coding format in the data processing circuit is modified according to the characteristics of the new coding format. For example, the new coding format is the improved version of the old coding format, and they have similar functions, but the speed of coding and decoding the image data in the new coding format increases a lot. Thus, the original data processing circuit may be slightly improved directly. Therefore, via the design of the invention, the complexity of developing a new processing circuit is reduced, and the time for developing a new processing circuit is reduced a lot.

FIG. 2B is a schematic diagram showing an improved architecture of the data processing circuit having a multi-format image coding and decoding function in the first embodiment of the invention. As shown in FIG. 2B, the number of each of executing units in the EX stage 430 is two. The EX stage 430 of the data processing circuit 400 includes the VLCD/CABAC executing units 432a and 432b, the QIQ executing units 433a and 433b, the TIT executing units 434a and 434b, the DIF executing units 435a and 435b and the Com/Est executing units 436a and 436b. This may increase the coding or decoding speed greatly. In addition, the parts in FIG. 2B and FIG. 1 having the same symbols have the same functions and characteristics, which are described in the illustration for FIG. 1.

FIG. 2C is a schematic diagram showing an improved architecture of the data processing circuit of the multi-format image coding and decoding function in the first embodiment of the invention. As shown in FIG. 2C, the EX stage 530 of the data processing circuit 500 includes a new TIT executing unit 534. When the image coding format is changed in the future, and for example, when the H.265 coding format comes out, the data processing circuit in the invention only needs to modify the corresponding unit supporting the old coding format such as the TIT executing unit 134 according to the characteristic of the H.265. By the sectional modification, the speed of coding and decoding the image data may increase. Due to the design of the invention, the complexity in developing new processing circuit is greatly reduced, and the time for developing the new processing circuit is also reduced greatly. In addition, the parts in FIG. 2C and FIG. 1 having the same symbols have the same functions and characteristics, which are described in the illustration for FIG. 1.

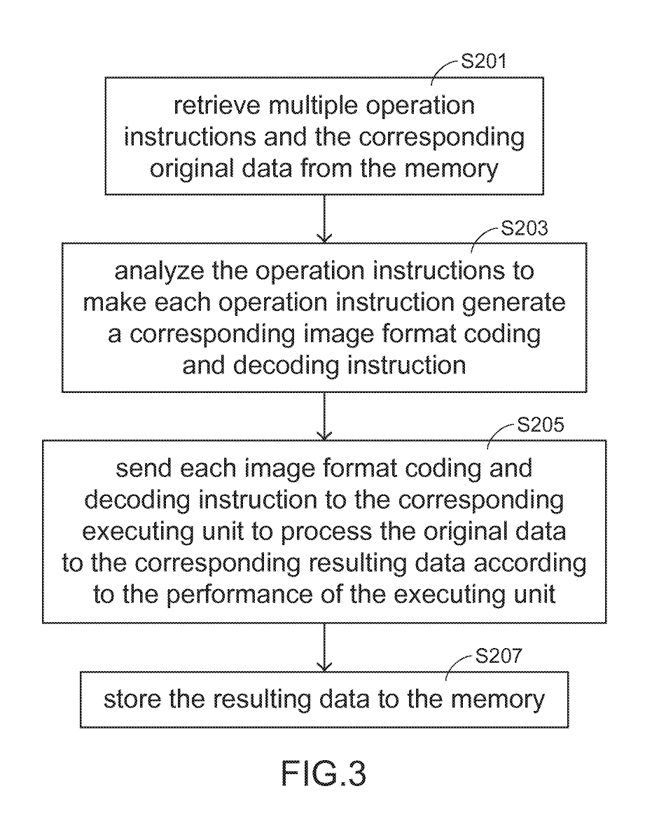

FIG. 3 is a flow chart showing the data processing method having the multi-format image coding and decoding function in the first embodiment of the invention. Firstly, multiple operation instructions and multiple corresponding original data are retrieved from the memory (step S201). Then, the operation instructions are analyzed to make each operation instruction generate a corresponding image format coding and decoding instruction (step S203). The image format coding and decoding instructions are sent to the corresponding executing units to process the original data to the corresponding resulting data according to the performance of the executing units (step S205). Each executing unit includes at least a VLCD/CABAC executing unit, an ADCD/SIS executing unit, a QIQ executing unit, a TIT executing unit, a DIF executing unit or a Com/Est executing unit for executing the corresponding image format coding and decoding instructions, namely the variable length coding instruction, the CABAC instruction, the AC/DC prediction instruction, the SIS instruction, the QIQ instruction, the TIT instruction, the DIF instruction or the Com/Est instruction. At last, the resulting data is selectively stored in the memory (step S207).

To sum up, the invention discloses the data processing circuit having the multi-format image coding and decoding function, and the data processing circuit may support multiple video formats and the coding or decoding of data with the multiple video formats. Thus, the data processing circuit has the advantages of high variability, high performance, low complexity and low power consumption.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A data processing circuit having a multi-format image coding and decoding function, the data processing circuit comprising:
a retrieving unit for retrieving multiple operation instructions and multiple original data from a memory;
multiple executing units, wherein each of the executing units is used for executing an image format coding and decoding instruction to process the original data to multiple resulting data; and
a instruction decoding unit for analyzing the operation instructions, generating multiple corresponding image format coding and decoding instructions and sending the image format coding and decoding instructions to the corresponding executing units according to the performance of the executing units.

2. The data processing circuit according to claim 1, wherein each of the executing units at least comprises an operation unit for executing the image format coding and decoding instructions.

3. The data processing circuit according to claim 2, wherein the operation units are a variable length coding or context adaptive binary arithmetic coding (VLCD/CABAC) executing unit, an alternating current/direct current (AC/DC) prediction or scanning and inverse scanning (ADCD/SIS) executing unit, a quantization and inverse quantization (QIQ) executing unit, a transform and inverse transform (TIT) executing unit, an de-blocking filter (DIF) executing unit or an intra/motion estimation and compensation (Com/Est) executing unit.

4. The data processing circuit according to claim 1, wherein the original data are multiple original image data, and the resulting data are image coding data.

5. The data processing circuit according to claim 4, wherein the image coding data are MPEG2 format data, MPEG4 format data, H.264 format data, VC-1 format data or RM format data.

6. The data processing circuit according to claim 1, wherein the original data are image coding data, and the resulting data are original image data.

7. The data processing circuit according to claim 6, wherein the image coding data are MPEG2 format data, MPEG4 format data, H.264 format data, VC-1 format data or RM format data.

8. The data processing circuit according to claim 1, further comprising:
a storage unit for storing the resulting data and storing the resulting data into the memory.

9. The data processing circuit according to claim 8, wherein the storage unit uses the direct memory access (DMA) to store the resulting data into the memory.

10. The data processing circuit according to claim 1, wherein the retrieving unit uses the DMA to retrieve the operation instructions and the original data from the memory.

11. The data processing circuit according to claim 1, wherein the image format coding and decoding instruction comprises a variable length coding (VLCD) instruction, a CABAC instruction, an AC/DC prediction instruction, a scanning and inverse scanning (SIS) instruction, a QIQ instruction, a TIT instruction, an DIF instruction or a Com/Est instruction.

12. A data processing method having a multi-format image coding and decoding function, the data processing method comprising the steps of:
retrieving multiple operation instructions and multiple corresponding original data from the memory;
analyzing the operation instructions to make each of the operation instructions generate a corresponding image format coding and decoding instruction; and
sending the image format coding and decoding instructions to multiple corresponding executing units to process the original data to corresponding resulting data according to the performance of the executing units.

13. The data processing method according to claim 12, wherein each of the executing units at least comprises an operation unit for executing the image format coding and decoding instruction.

14. The data processing method according to claim 13, wherein the operation unit is a VLCD/CAB AC executing unit, an ADCD/SIS executing unit, a QIQ executing unit, a TIT executing unit, a DIF executing unit or a Com/Est executing unit.

15. The data processing method according to claim 12, wherein the original data are multiple original image data, and the resulting data are image coding data.

16. The data processing method according to claim 15, wherein the image coding data are MPEG2 format data, MPEG4 format data, H.264 format data, VC-1 format data or RM format data.

17. The data processing method according to claim 12, wherein the original data are multiple image coding data, and the resulting data are original image data.

18. The data processing method according to claim 17, wherein the image coding data are MPEG2 format data, MPEG4 format data, H.264 format data, VC-1 format data or RM format data.

19. The data processing method according to claim 12, further comprising the step of:
storing the resulting data by a buffer unit temporarily.

20. The data processing method according to claim 12, further comprising the step of:
storing the resulting data to the memory.

21. The data processing method according to claim 20, wherein the step of storing the resulting data to the memory is realized by DMA.

22. The data processing method according to claim 12, wherein the step of retrieving the operation instructions and the corresponding original data from the memory further comprises:
retrieving the operation instructions and the original data from the memory using the DMA.

23. The data processing method according to claim 12, wherein the image format coding and decoding instruction is a VLCD instruction, a CABAC instruction, an AC/DC prediction instruction, a SIS instruction, a QIQ instruction, a TIT instruction, a DIF instruction or a Com/Est instruction.
